(19) United States
(12) Patent Application Publication
(10) Pub. No.: US 2018/0215024 A1
(43) Pub. Date: Aug. 2, 2018

(54) Nail Driving Assembly

(71) Applicant: Craig Carlson, Clifton, NJ (US)

(72) Inventor: Craig Carlson, Clifton, NJ (US)

(21) Appl. No.: 15/417,766

(22) Filed: Jan. 27, 2017

(51) Int. Cl. B25C 3/00

(52) U.S. Cl. CPC B25C 3/006

(57) ABSTRACT

A nail driving assembly for driving a nail without bending over includes a tube that may be gripped. The tube has a length of at least 90 cm. Thus, the tube extends between a support surface and a user without having the user bend over. A striking unit is slidably positioned in the tube and the striking unit is selectively aligned with a nail in the support surface. The striking unit is selectively struck thereby facilitating the striking unit to drive the nail without having the user bend over.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to driving devices and more particularly pertains to a new driving device for driving a nail without bending over.

### BRIEF SUMMARY OF THE INVENTION

An embodiment of the disclosure meets the needs presented above by generally comprising a tube that may be gripped. The tube has a length of at least 90 cm. Thus, the tube extends between a support surface and a user without having the user bend over. A striking unit is slidably positioned in the tube and the striking unit is selectively aligned with a nail in the support surface. The striking unit is selectively struck thereby facilitating the striking unit to drive the nail without having the user bend over.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of a nail driving assembly according to an embodiment of the disclosure.

FIG. 2 is a bottom view of an embodiment of the disclosure.

FIG. 3 is a cross sectional view taken along line 3-3 of FIG. 2 of an embodiment of the disclosure.

FIG. 4 is a perspective in-use view of an embodiment of the disclosure.

### DETAILED DESCRIPTION OF THE INVENTION

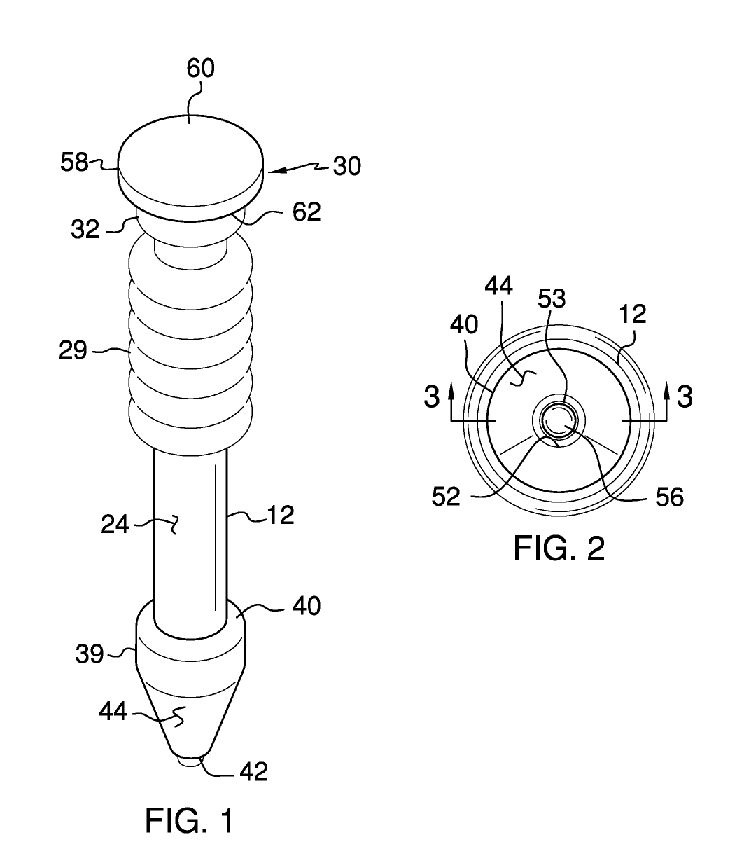

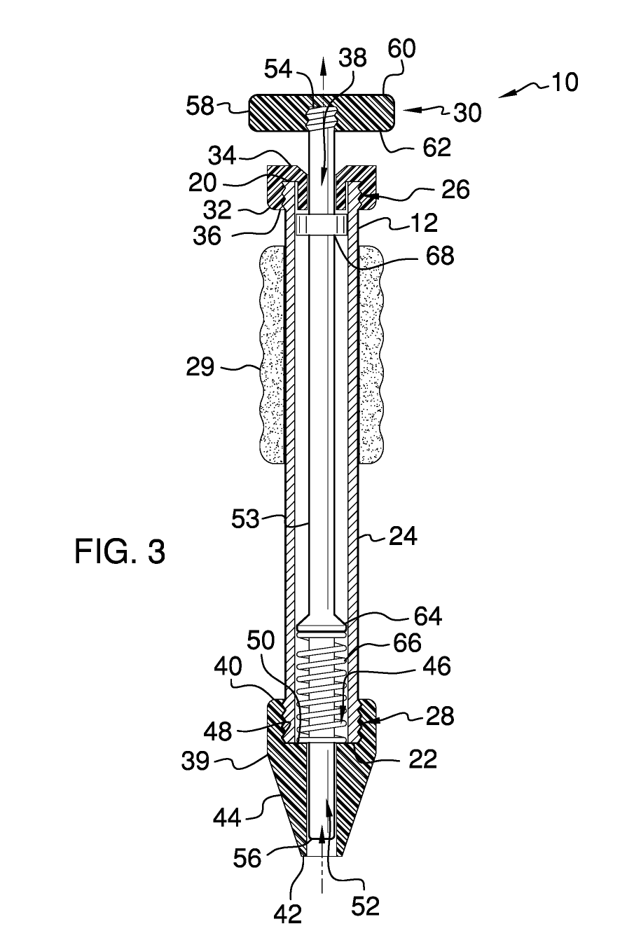

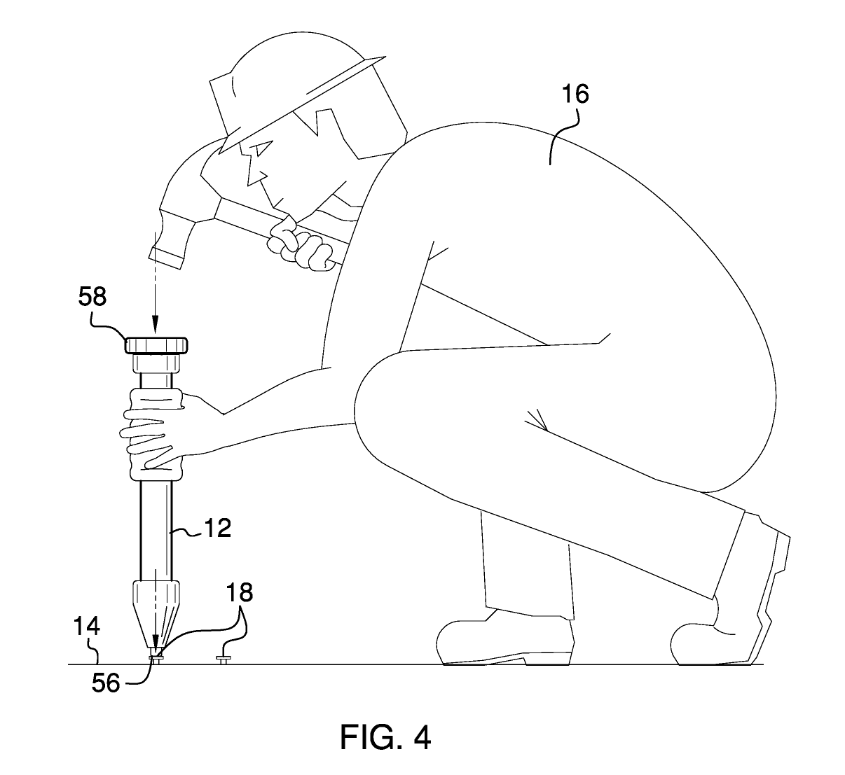

With reference now to the drawings, and in particular to FIGS. 1 through 4 thereof, a new driving device embodying the principles and concepts of an embodiment of the disclosure and generally designated by the reference numeral 10 will be described.

As best illustrated in FIGS. 1 through 4, the nail driving assembly 10 generally comprises a tube 12 that is selectively gripped and the tube 12 has a length of at least 90.0 cm. Thus, the tube 12 extends between a support surface 14 and a user 16 without having the user 16 bend over. The support surface 14 may be a wooden structure such as a deck or the like and the support surface 14 may include a plurality of nails 18.

The tube 12 has a first end 20, a second end 22 and an outer surface 24 extending therebetween. Each of the first end 20 and the second end 22 is open and the tube 12 is substantially hollow. The outer surface 24 has a first threaded portion 26 that is aligned with the first end 20. The outer surface 24 has a second threaded portion 28 that is aligned with the second end 22.

A grip 29 is positioned around the tube 12 to enhance gripping the tube 12. The grip 29 is positioned closer to the first end 20 than the second end 22. Moreover, the grip 29 is comprised of a resiliently compressible material such as rubber or the like.

A striking unit 30 is provided and the striking unit 30 is slidably positioned in the tube 12. The striking unit 30 is selectively aligned with a nail 18 in the support surface 14. The striking unit 30 is selectively struck with a hammer or the like. In this way the striking unit 30 drives the nail 18 into the support surface 14 without having the user 16 bend over.

The striking unit 30 comprises a first cap 32 that has a first surface 34 and a second surface 36. The first cap 32 has a first aperture 38 extending through the first surface 34 and the second surface 36. The first cap 32 threadably engages the first threaded portion 26 of the tube 12 and the first aperture 38 is aligned with an interior of the tube 12. A second cap 39 is provided that has a primary end 40, a secondary end 42 and an outside surface 44 extending therebetween. The outside surface 44 tapers between the primary end 40 and the secondary end 42 such that the second cap 39 has a conical shape.

The primary end 40 has a well 46 extending toward the secondary end 42 and the well 46 has an outer bounding surface 48 and a lower bounding surface 50. The second cap 39 has a second aperture 52 extending through the well 46 and the secondary end 42. The outer bounding surface 48 of the well 46 threadably engages the second threaded portion 28 on the tube 12 having the well 46 being aligned with the bottom end of the tube 12. The second aperture 52 is selectively aligned with the nail 18 in the support surface 14.

A shaft 53 is provided that has a top end 54 and a bottom end 56. The shaft 53 is slidably positioned in the tube 12 having the top end 54 extending upwardly through the first aperture 38 in the first cap 32. The bottom end 56 of the shaft 53 extends downwardly into the second aperture 52 in the second cap 39.

A disk 58 is provided that has a top side 60 and a bottom side 62. The bottom side 62 threadably engages the top end 54 of the shaft 53 having the shaft 53 being centrally located on the disk 58. The top side 60 is selectively struck thereby facilitating the shaft 53 to be urged downwardly in the tube 12. Moreover, the bottom end 56 of the shaft 53 extends outwardly from the second aperture 52 in the second cap 39 when the disk 58 is struck. In this way the bottom end 56 of the shaft 53 drives the nail 18 into the support surface 14.

A first stop 64 is positioned around the shaft 53 and the first stop 64 is positioned closer to the bottom end 56 than the top end 54. The first stop 64 is positioned within the tube 12. A biasing member 66 is positioned around the shaft 53. The biasing member 66 extends between the lower bounding surface 50 of the well 46 in the second cap 39 and the first stop 64. Moreover, the biasing member 66 biases the shaft 53 upwardly in the tube 12 having the bottom end 56 of the shaft 53 being recessed into the second cap 39. The biasing member 66 may be a spring or the like.

A second stop 68 is provided and the second stop 68 is positioned around the shaft 53. The second stop 68 is positioned closer to the top end 54 than the bottom end 56. Additionally, the second stop 68 abuts the second surface 36 of the first cap 32 when the biasing member 66 biases the shaft 53 upwardly in the tube 12. In this way the second stop 68 inhibits the shaft 53 from being removed from the tube 12.

In use, the grip 29 is gripped and the tube 12 is oriented vertically with respect to the support surface 14. The secondary end 42 of the second cap 39 is aligned with the nail 18 in the support surface 14. The nail 18 may have been previously driven into the support surface 14 and has loosened such that the nail 18 is no longer fully driven into the support surface 14. The length of the tube 12 facilitates the secondary end 42 of the second cap 39 to be aligned with the nail 18 without having the user 16 bend over. In this way the tube 12 eases back pain associated with bending over to drive the nail 18. The disk 58 is struck with the hammer or other implement and the second end of the shaft 53 drives the nail 18. The tube 12 is selectively aligned with any of a plurality of nails 18 that need to be re-driven into the support surface 14.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A nail driving assembly being configured to facilitate a nail to be driven without bending over to drive the nail, said assembly comprising:
a tube being configured to be gripped, said tube having a length of at least 90 cm wherein said tube is configured to extend between a support surface and a user without having the user bend over; and
a striking unit being slidably positioned in said tube, said striking unit being configured to be aligned with a nail in the support surface, said striking unit being configured to be selectively struck thereby facilitating said striking unit to drive the nail without having the user bend over.

2. The assembly according to claim 1, wherein said tube has a top end, a bottom end and an outer surface extending therebetween, each of said top end and said bottom end being open, said outer surface having a first threaded portion being aligned with said top end, said outer surface having a second threaded portion being aligned with said bottom end.

3. The assembly according to claim 2, further comprising a grip being positioned around said tube wherein said grip is configured to enhance gripping said tube, said grip being positioned closer to said first end than said second end.

4. The assembly according to claim 1, wherein:
said tube has a first threaded portion; and
said striking unit comprises a first cap having a first surface and a second surface, said first cap having a first aperture extending through said first surface and said second surface, said first cap threadably engaging said first threaded portion of said tube having said first aperture being aligned with an interior of said tube.

5. The assembly according to claim 1, further comprising a second cap having a primary end, a secondary end and an outside surface extending therebetween, said outside surface tapering between said primary end and said secondary end such that said second cap has a conical shape.

6. The assembly according to claim 5, wherein said primary end has a well extending toward said secondary end, said well having an outer bounding surface and a lower bounding surface, said second cap having a second aperture extending through said well and said secondary end.

7. The assembly according to claim 6, wherein:
said tube has a second threaded portion and a bottom end; and
said outer bounding surface threadably engaging said second threaded portion on said tube having said well being aligned with said second end of said tube, said second aperture being configured to be aligned with the nail.

8. The assembly according to claim 6, further comprising:
a first cap having a first aperture; and
a shaft having a first end and a second end, said shaft being slidably positioned in said tube having said first end extending upwardly through said first aperture in said first cap and said second end extending downwardly into said second aperture in said second cap.

9. The assembly according to claim 8, further comprising a disk having a top side and a bottom side, said bottom side threadably engaging said top end of said shaft having said shaft being centrally located on said disk, said top side being configured to be selectively struck thereby facilitating said shaft to be urged downwardly in said tube, said bottom end of said shaft extending outwardly from said second aperture in said second cap when said disk is struck wherein said bottom end is configured to drive the nail.

10. The assembly according to claim 8, further comprising a first stop being positioned around said shaft, said first stop being positioned closer to said bottom end than said top end, said first stop being positioned within said tube.

11. The assembly according to claim 10, further comprising a biasing member being positioned around said shaft, said biasing member extending between said lower bounding surface of said well in said second cap and said first stop, said biasing member biasing said shaft upwardly in said tube having said bottom end of said shaft being recessed into said second cap.

12. The assembly according to claim 4, further comprising:
a shaft being slidably positioned within said tube, said shaft having a top end and a bottom end;
a biasing member being positioned around said shaft; and
a second stop being positioned around said shaft, said second stop being positioned closer to said top end than said bottom end, said second stop abutting said second surface of said first cap when said biasing member biases said shaft upwardly in said tube such that said second stop inhibits said shaft from being removed from said tube.

13. A nail driving assembly being configured to facilitate a nail to be driven without bending over to drive the nail, said assembly comprising:
a tube being configured to be gripped, said tube having a length of at least 90 cm wherein said tube is configured to extend between a support surface and a user without having the user bend over, said tube having a first end, a second end and an outer surface extending therebetween, each of said first end and said second end being open, said outer surface having a first threaded portion being aligned with said first end, said outer surface having a second threaded portion being aligned with said second end;
a grip being positioned around said tube wherein said grip is configured to enhance gripping said tube, said grip being positioned closer to said first end than said second end; and
a striking unit being slidably positioned in said tube, said striking unit being configured to be aligned with a nail in the support surface, said striking unit being configured to be selectively struck thereby facilitating said striking unit to drive the nail without having the user bend over, said striking unit comprising:
a first cap having a first surface and a second surface, said first cap having a first aperture extending through said first surface and said second surface, said first cap threadably engaging said first threaded portion of said tube having said first aperture being aligned with an interior of said tube,
a second cap having a primary end, a secondary end and an outside surface extending therebetween, said outside surface tapering between said primary end and said secondary end such that said second cap has a conical shape, said primary end having a well extending toward said secondary end, said well having an outer bounding surface and a lower bounding surface, said second cap having a second aperture extending through said well and said secondary end, said outer bounding surface threadably engaging said second threaded portion on said tube having said well being aligned with said second end of said tube, said second aperture being configured to be aligned with the nail,
a shaft having a top end and a bottom end, said shaft being slidably positioned in said tube having said top end extending upwardly through said first aperture in said first cap and said bottom end extending downwardly into said second aperture in said second cap,
a disk having a top side and a bottom side, said bottom side threadably engaging said top end of said shaft having said shaft being centrally located on said disk, said top side being configured to be selectively struck thereby facilitating said shaft to be urged downwardly in said tube, said bottom end of said shaft extending outwardly from said second aperture in said second cap when said disk is struck wherein said bottom end is configured to drive the nail,
a first stop being positioned around said shaft, said first stop being positioned closer to said bottom end than said top end, said first stop being positioned within said tube,
a biasing member being positioned around said shaft, said biasing member extending between said lower bounding surface of said well in said second cap and said first stop, said biasing member biasing said shaft upwardly in said tube having said bottom end of said shaft being recessed into said second cap, and
a second stop being positioned around said shaft, said second stop being positioned closer to said top end than said bottom end, said second stop abutting said second surface of said first cap when said biasing member biases said shaft upwardly in said tube such that said second stop inhibits said shaft from being removed from said tube.
